(19) United States
(12) Patent Application Publication
(10) Pub. No.: US 2013/0268953 A1
(43) Pub. Date: Oct. 10, 2013

(54) USE OF SCORING IN A SERVICE

(71) Applicant: Andrey N. Nikankin, Sankt-Petersburg (RU)

(72) Inventor: Andrey N. Nikankin, Sankt-Petersburg (RU)

(73) Assignee: RAWLLIN INTERNATIONAL INC.

(21) Appl. No.: 13/442,565

(22) Filed: Apr. 9, 2012

(51) Int. Cl. H04N 21/65

(52) U.S. Cl. 725/9

(57) ABSTRACT

Systems, methods, and apparatus for dynamically providing an incentive to a customer of a service based on a detected unexpected behavior of the customer are presented herein. A model component can create a model associated with a service based on information associated with a use of the service. Further, a prediction component can predict, based on the model, a behavior of a user associated with the use of the service. Furthermore, a scoring component can identify a deviation from the behavior and determine an action associated with the user based on the deviation from the behavior. In an aspect, the action can be communication of an incentive directed to a network-enabled device.

### TECHNICAL FIELD

The subject disclosure relates generally to services, and more particularly to use of scoring in a service.

### BACKGROUND

With the advent of the Internet and widespread consumer access to network data content, conventional systems have expanded to providing Internet media services. For instance, television content providers traditionally offering television services over television-assigned spectrum or direct cable line, etc. can store television media on network data stores and offer such media for consumption over the Internet in the form of streaming media. Further, computing devices configured to communicate on the Internet can generally be employed to access, acquire, consume, playback, etc. various networked media content. For instance, Internet-ready television sets enable access of websites that provide streaming media content.

Although consumers can access streaming media content via conventional networked media techniques, such techniques cannot adequately provide incentives to consumers in conjunction with video on demand streaming media services.

The above-described deficiencies of today's networked media techniques and related technologies are merely intended to provide an overview of some of the problems of conventional technology, and are not intended to be exhaustive, representative, or always applicable. Other problems with the state of the art, and corresponding benefits of some of the various non-limiting embodiments described herein, may become further apparent upon review of the following detailed description.

### SUMMARY

A simplified summary is provided herein to help enable a basic or general understanding of various aspects of illustrative, non-limiting embodiments that follow in the more detailed description and the accompanying drawings. This summary is not intended, however, as an extensive or exhaustive overview. Instead, the sole purpose of this summary is to present some concepts related to some illustrative non-limiting embodiments in a simplified form as a prelude to the more detailed description of the various embodiments that follow. It can also be appreciated that the detailed description will include additional or alternative embodiments beyond those described in this summary.

In accordance with one or more embodiments and corresponding disclosure, various non-limiting aspects are described in connection with use of scoring in a service, e.g., a commercial service, an on-line service, a video-on-demand (VOD) streaming media service, etc. In one or more aspects, component(s) associated with a VOD service can detect unexpected behavior of respective consumers of the VOD service, and dynamically provide incentives to the respective consumers based on such behavior. For example, such component(s) can facilitate provisioning, e.g., by content providers, of Internet media content to such consumers by facilitating further interest in newly detected, unexpected trends in behavior of the respective consumers. Such interest can be facilitated by providing incentives to customers on-the-fly to facilitate customer interest in experiencing, for example, a genre of movie, TV, music, etc. determined to be of interest to the customers based on the detected unexpected behavior, trend(s), etc.

For instance, a model component can create a model, e.g., a linear regression model, etc. associated with a data service, e.g., a VOD streaming media service, an on-demand television (TV) service, etc. based on information associated with a use of the data service, e.g., in response to receiving a request, from a customer of the data service, for viewing a movie, viewing TV content, listing a genre of media content, listening to radio and/or music, etc.

In one or more aspects, the information can indicate: a gender of the customer, an age of the customer, a balance of an account of the customer, e.g., associated with a time of a first purchase by the customer, an amount of a first deposit into the account, and/or a use of a social network and/or associated profile affiliated with the customer, e.g., during a registration of the customer on the data service.

In one or more other aspects, the information can indicate: a number of TVs associated with, or linked to, the customer, a duration of time of a use of the data service by the customer, e.g., after the registration, a number of web pages of the data service queried, visited, etc. after the registration, an average time of use of the data service by the customer per month, an average duration of movie content rented by, purchased by, etc. the customer, a total duration of movie content rented by, purchased by, etc. the customer, and/or a total duration of movie content rented by, purchased by, etc. the customer for use via a television.

In other aspect(s), the information can indicate: whether a customer of the data service utilized search features of the data service during a first use of the data service, a number of titles rated by the customer during the first use, a number of comments received from the user during the first use, a degree of loyalty of the customer to the data service, a number of virtual friends of the customer that utilize the data service, a total number of devices linked to the data service, a total number of holidays in a selected month, and/or a total number of weekend days in a selected month.

In one aspect, a device, e.g., a network-enabled device associated with the customer, can be linked to the data service in response to being communicatively coupled to the data service. In another aspect, the device can be linked to the data service in response to being associated, registered, etc. with the data service, e.g., via the customer indicating ownership of the device, e.g., during registration of an account associated with the data service, etc.

Further, a prediction component can predict, based on the model, a behavior, trend in behavior, etc. of the customer. In one more aspects, the behavior can include: a total number of rentals, purchases, etc. of media content requested from the data service by the customer during a period of time, e.g., month, etc. and/or a genre of the media content of interest to the customer.

Furthermore, a scoring component can identify, determine, etc. a deviation from the behavior, e.g., by monitoring one or more activities of a networked-enabled device, networked-enable TV, etc. that are associated with the customer, and determine, identify, etc. the deviation in response to the one or more activities being different than the predicted behavior, trend in behavior, etc.

In at least one aspect, the one or more activities can include a request, received from the networked-enabled device, to view, experience, rent, purchase, etc. media content from the data service, and/or a request, received from the networked-enabled device, for a genre of media content, e.g., to be reviewed via the data service. Further, the scoring component can determine an action, course of action, etc. associated with the customer based on the deviation from the behavior. In an aspect, the action can include communicating an incentive directed to the network-enabled device, e.g., for enhancing customer experience(s) in facilitating further interest in a new trend, in facilitating further interest in the predicted behavior, trend in behavior, etc.

In another aspect, a regression component can generate a linear regression model associated with the data service based on data associated with the customer, and predict the behavior of the customer based on the linear regression model. For example, the linear regression model can iteratively disassociate, remove, etc. dependent parameters from the linear regression model based on the data associated with the customer. In yet another aspect, a planning component can modify a service plan associated with the data service based on the deviation from the behavior, e.g., increase incentives directed to the network-enabled device in response to determining consistent deviations from the customer.

In one non-limiting implementation, a method can include creating, by a system, a model of behavior associated with a data streaming service, e.g., a VOD service, in response to a use, e.g., purchasing a movie rental, etc. of the data streaming service. Further, the method can include predicting, by the system based on the model of the behavior, a behavior, trend, etc. of a user associated with the use. In an aspect, the trend can indicate a number of movie rentals requested by the user per period of time, e.g., a month. In another aspect, the trend can indicate a genre of movie rental requests associated with the user. Furthermore the method can include identifying, by the system, a deviation from the behavior, the trend, etc. In one aspect, the deviation can indicate a lack of activity, e.g., a lack of rental activity, associated with the user per period of time. Further, the method can include determining, by the system based on the deviation, an action associated with the user.

In one aspect, the determining can include determining, by the system, an incentive, and communicating, by the system, the incentive directed to a networked-enabled computing device, e.g., TV, associated with the user. In another aspect, the creating the model of behavior can include updating, by the system, a linear regression model associated with the data service based on data associated with the user. In yet another aspect, the updating can include iteratively removing, by the system, dependent parameters from the linear regression model based on the data associated with the user.

In an aspect, the predicting can include predicting, by the system, a total number of rentals of media content, e.g., movie rentals, associated with the user and requested from the data service during a period of time, and/or predicting, by the system, a genre of media content, e.g., movie content, of interest to the user. In one aspect, the identifying the deviation can include detecting, by the system, an activity associated with the network-enabled device associated with the user, and determining, by the system, the deviation in response to the activity being different from the behavior. In another aspect, the detecting the activity can include receiving, by the system, a request associated with a rental of media content, and/or a request for a genre of media content.

In yet another aspect, the method can include modifying a service plan associated with the data service based on the deviation from the behavior. For example, a service plan associated with a number of movie rentals per period of time can be modified and communicated to the network-enabled computing device, e.g., for acceptance by the user.

In another non-limiting implementation, a method can include receiving data associated with a user of a data streaming service. For example, the data can indicate: a gender of the customer, an age of the customer, a balance of an account of the customer, e.g., associated with a time of a first purchase by the customer, an amount of a first deposit into the account, and/or a use of a social network and/or associated profile affiliated with the customer, e.g., during a registration of the customer on the data service. In one or more other aspects, the information can indicate: a number of TVs associated with, or linked to, the customer, a duration of time of a use of the data service by the customer, e.g., after the registration, a number of web pages of the data service queried, visited, etc. after the registration, an average time of use of the data service by the customer per month, an average duration of movie content rented by, purchased by, etc. the customer, a total duration of movie content rented by, purchased by, etc. the customer, and/or a total duration of movie content rented by, purchased by, etc. the customer for use via a television.

In other aspect(s), the information can indicate: whether a customer of the data service utilized search features of the data service during a first use of the data service, a number of titles rated by the customer during the first use, a number of comments received from the user during the first use, a degree of loyalty of the customer to the service, a number of virtual friends of the customer that utilize the data service, a total number of devices linked to the service, a total number of holidays in a selected month, and/or a total number of weekend days in a selected month.

Further, the method can include creating a model associated with the user based on the data; predicting, based on the model, a trend of behavior of the user; identifying a deviation from the trend; and determining an incentive for the user based on the deviation. In one aspect, the operations can include communicating the incentive directed to a network-enabled device associated with the user. In another aspect, the creating can include creating a linear regression model based on the data, determining whether the linear regression model includes dependent parameter(s), and disassociating, removing, deleting, etc. at least a portion of the dependent parameter(s) from the data.

Other embodiments and various non-limiting examples, scenarios, and implementations are described in more detail below.

### BRIEF DESCRIPTION OF THE DRAWINGS

FIG. 1 illustrates a block diagram of streaming media environment, in accordance with one or more embodiments.

FIG. 2 illustrates a block diagram of a data service system, in accordance with one or more embodiments.

FIG. 3 illustrates a block diagram of a data service system including a regression component, in accordance with one or more embodiments.

FIG. 4 illustrates a block diagram of a data service system including a planning component, in accordance with one or more embodiments.

FIGS. 5-8 illustrate various processes associated with one or more streaming media environments, in accordance with one or more embodiments.

FIG. 9 illustrates a block diagram of a computing system operable to execute the disclosed systems and methods, in accordance with an embodiment.

FIG. 10 illustrates a block diagram of a sample data communication network that can be operable in conjunction with various aspects described herein.

### DETAILED DESCRIPTION

Various non-limiting embodiments of systems, methods, and apparatus presented herein dynamically provision a virtual storage appliance in a cloud computing environment. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used, via model component 106 (see below), to create a model associated with a data service based on information associated with a use of the data service. Further, the artificial intelligence system can be used, via prediction component 108 (see below), predict, based on the model, a behavior, e.g., a trend towards renting a particular genre of movie content, of a user, e.g., a customer, associated with the use of the data service. Furthermore, the artificial intelligence system can be used, via scoring component 110 (see below), to identify a deviation from the behavior and determine an action associated with the user, e.g., determine an incentive to communicate to the user, based on the deviation from the behavior.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

As described above, conventional networked media techniques cannot adequately provide incentives to consumers in conjunction with video on demand streaming media services. Compared to such technology, various systems, methods, and apparatus described herein in various embodiments can facilitate provisioning of Internet media content a consumer in response to detecting a deviation in behavior of the user from a predicted behavior of the consumer. In other aspects, such embodiments can improve respective customer experiences by facilitating further interest in “new trends” associated with detected deviations in behavior.

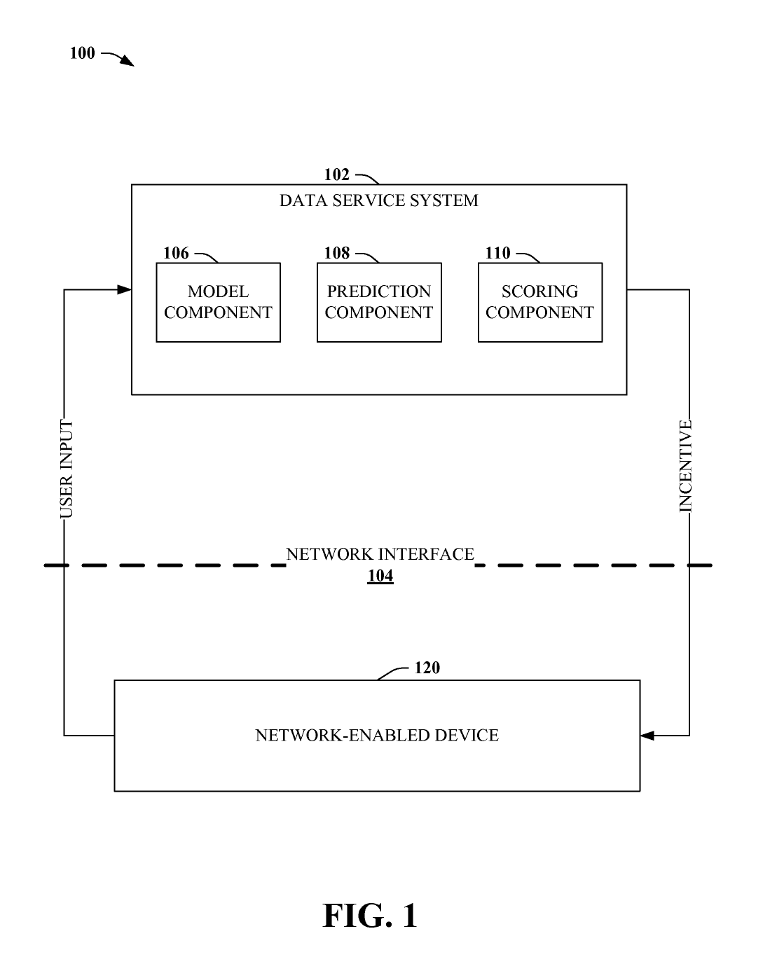

Referring now FIG. 1, a block diagram of a streaming media environment 100 is illustrated, in accordance with one or more embodiments. Aspects of streaming media environment 100, and systems, networks, other apparatus, and processes explained herein can constitute machine-executable instructions embodied within machine(s), e.g., embodied in one or more computer readable mediums (or media) associated with one or more machines. Such instructions, when executed by the one or more machines, e.g., computer(s), computing device(s), virtual machine(s), etc. can cause the machine(s) to perform the operations described.

Additionally, the systems and processes explained herein can be embodied within hardware, such as an application specific integrated circuit (ASIC) or the like. Further, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Streaming media environment 100 can include a data service system 102 that can include model component 106, prediction component 108, and scoring component 110. In an aspect, data service system 102 can be communicatively coupled, via network interface 104, to network-enabled device 120, e.g., a network-enabled television that can include any suitable video playback device having an interface to a conventional broadcast video and audio signal, e.g., licensed television frequency, cable television hookup, optical fiber television hookup, satellite television hookup, or the like, or a suitable combination thereof, etc.

In another aspect, network interface 104 can include an Internet Protocol (IP) based network, such as the Internet, a local network, a wide area network, an intranet, or the like. It should be appreciated that network interface 104 can be a network that employs other communication or data transfer protocols, or that uses IP in conjunction with one or more other protocols, in one or more aspects of the subject disclosure.

As illustrated by FIG. 1, data service system 102 can receive an input from a user, or user input, associated with a use of a VOD streaming media service, e.g., an on-demand TV service, etc. provided by data service system 102 via network interface 104, e.g., based on an IP communication session. In an aspect, the use can be associated with a request for purchasing a VOD streaming media service, e.g., a movie rental, etc. via data service system 102. Model component 106 can create a model, e.g., a linear regression model, etc. associated with the VOD streaming media service based on information associated with a use of the VOD streaming media service. For example, the information can be associated with the user input received from network-enabled device 120, e.g., associated with a request for viewing a movie, viewing TV content, listing a genre of media content, listening to radio and/or music, etc. In another example, the information can be associated with an account associated with the VOD streaming media service and including personal information about the user, e.g., age, sex, information associated with prior use of VOD streaming media service by the customer, etc.

Further, prediction component 108 can predict, based on the model, a behavior, trend in behavior, etc. of the user. In one more aspects, the behavior can include a total number of rentals, purchases, etc. of media content requested from the VOD streaming media service by the user during a period of time, e.g., month, etc. and/or include a genre of the media content of interest to the user. For example, a trend in a genre of movies preferred by the user can be predicted. In another example, a trend in an average amount of movie rentals purchased by the user on a monthly basis can be predicted.

Furthermore, scoring component 110 can identify, determine, etc. a deviation from the behavior, e.g., by monitoring one or more activities of networked-enabled device 120 associated with the VOD streaming media service, and determining, identifying, etc. the deviation in response to the one or more activities being different than the predicted behavior, trend in behavior, etc. For example, scoring component 110 can identify that the user requested information associated with a genre of movies different from another genre of movies predicted to be preferred by the user. In another example, scoring component 110 can identify that the user has not requested a movie rental by the 20^{th} day of a month, different from a predicted trend for the user indicating the user purchased, for example, an average of two movie rentals per month.

Further, scoring component 110 can determine an action, course of action, etc. associated with the user based on the deviation from the behavior. In an aspect, the course of action can include communicating an incentive directed to network-enabled device 120, e.g., for encouraging further interest in the predicted trend, re-guiding the user's actions towards the predicted trend, e.g., for enhancing experience(s) of the user, for facilitating provisioning, e.g., by content provider(s), of Internet media content to the user, etc.

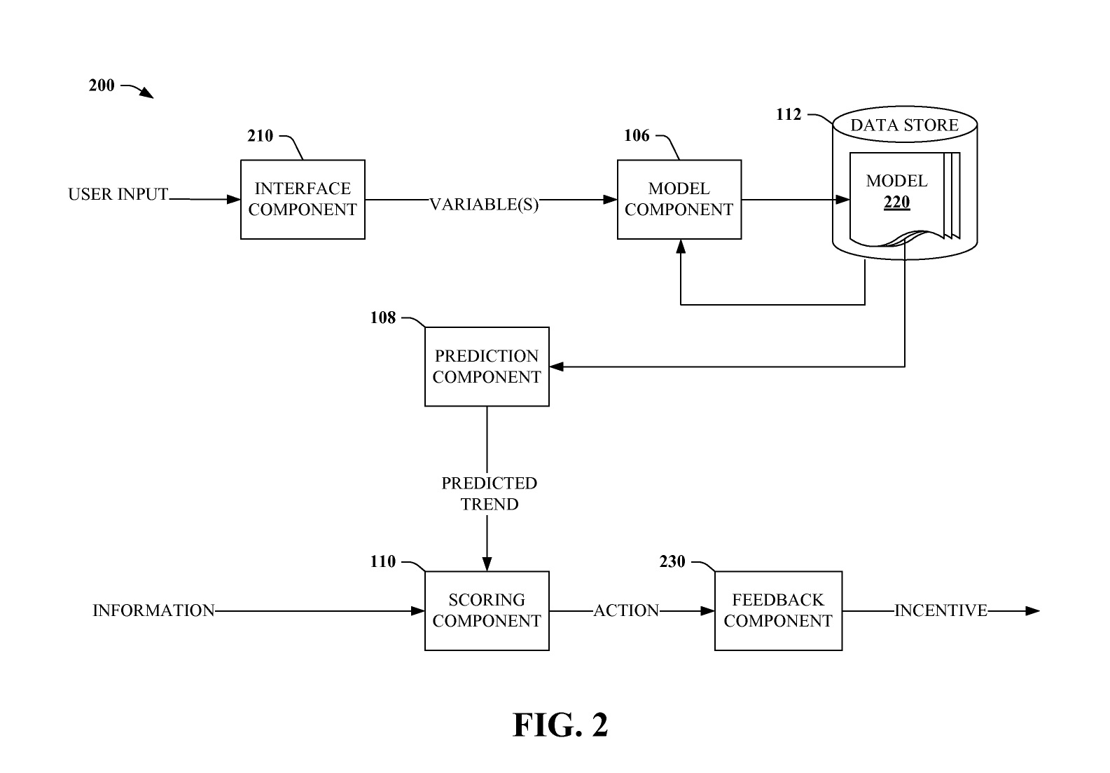

Now referring to FIG. 2, a block diagram of a data service system 200 is illustrated, in accordance with one or more embodiments. Data service system 200 can include components of data service system 102, including interface component 210, model 220, and feedback component 230. Interface component 210 can receive user input via an IP based network, such as the Internet, a local network, a wide area network, an intranet, or the like, and generate variables identifying respective parameters associated with the user input. For example, the variables can identify respective parameters associated with a request for viewing a movie, viewing TV content, listing a genre of media content, listening to Internet radio and/or music, etc.

Model component 106 can create model 220 utilizing the variables identifying respective parameters associated with the request. In another aspect, model component 106 can create model 220 utilizing account information, e.g., stored in data store 112, associated with the user, or customer, of a VOD streaming media service. Such information can indicate: a gender of the customer, an age of the customer, a balance of an account of the customer, e.g., associated with a time of a first purchase by the customer, an amount of a first deposit into the account, and/or a use of a social network and/or associated profile affiliated with the customer, e.g., during a registration of the customer on the VOD streaming media service.

In one or more other aspects, the information can indicate: a number of TVs associated with, or linked to, the customer, a duration of time of a use of the VOD streaming media service by the customer, e.g., after the registration, a number of web pages of the VOD streaming media service that were queried, visited, etc. after the registration, an average time of use of the VOD streaming media service by the customer per month, an average duration of movie content rented by, purchased by, etc. the customer, a total duration of movie content rented by, purchased by, etc. the customer, and/or a total duration of movie content rented by, purchased by, etc. the customer for use via network-enabled device 120, e.g., a TV, a computer, a handheld computing device, etc.

In other aspect(s), the information can indicate: whether the customer utilized search features of the VOD streaming media service during a first use of the VOD streaming media service, a number of titles rated by the customer during the first use, a number of comments received from the user during the first use, a degree of loyalty of the customer to the VOD streaming media service, a number of virtual friends of the customer that utilize the VOD streaming media service, a total number of devices linked to the VOD streaming media service, a total number of holidays in a selected month, and/or a total number of weekend days in a selected month.

Prediction component 108 can predict a trend, trend of behavior, behavior, etc. of the customer of the VOD streaming media service utilizing model 220. In at least one aspect, the trend can include a total number of rentals, purchases, etc. of media content requested by the customer from the VOD streaming media service during a period of time, e.g., month, season, etc. In another aspect, the trend can include a genre of media content of the VOD streaming media service preferred by the user.

Scoring component 110 can determine a deviation from the trend based on information associated with one or more activities of networked-enabled device 120. For example, such information can be associated with user input received from interface component 210, e.g., scoring component 110 can receive information indicating the customer has not rented movies from the VOD streaming media service for two months, while the trend indicates the customer has rented an average of four movies per month.

Further, scoring component 110 can determine an action based on the deviation, e.g., encourage, via incentive(s), the customer to rent movies associated with the predicted trend, encourage the customer to rent movies associated with the deviation from the predicted trend, etc. Feedback component 230 can communicate the incentive(s), e.g., including coupons, movie rental discounts, etc. directed to networked-enabled device 120.

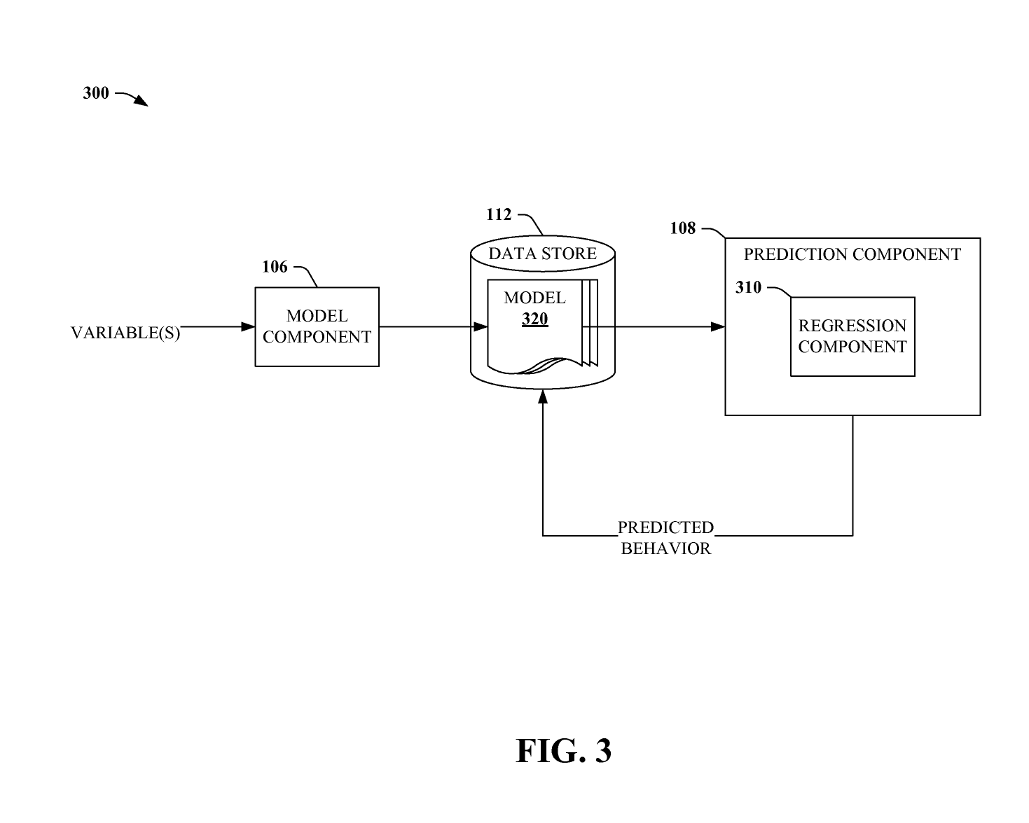

FIG. 3 illustrates a block diagram of a data service system 300 including a regression component 310, in accordance with one or more embodiments. Regression component 310 can generate linear regression model 320 associated with a data service, e.g., a VOD streaming media service, based on data associated with a customer, or user, of the VOD streaming media service. For example, regression component 310 can generate model 320 by modifying a model, e.g., model 220. In an aspect, regression component 310 can modify the model by iteratively disassociating, removing, deleting, etc. dependent parameters from model 320. In one aspect, prediction component 108 can utilize linear regression model 320 to predict a trend for the user.

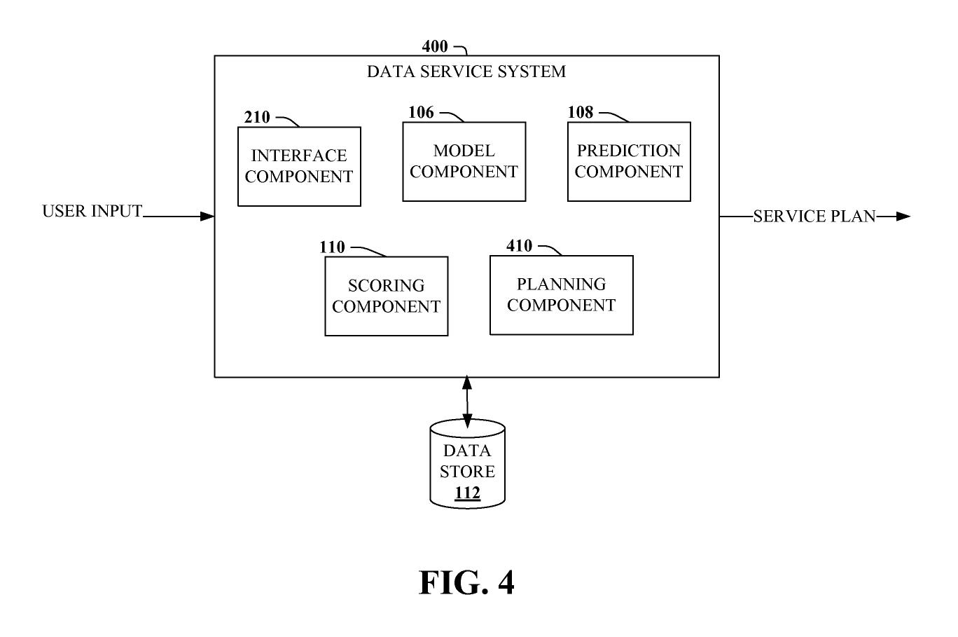

Now referring to FIG. 4 a block diagram of a data service system 400 including planning component 410 is illustrated, in accordance with one or more embodiments. Planning component 410 can modify a service plan associated with the data service, e.g., the VOD streaming media service, based on the deviation from the behavior. In one example, the service plan can be modified to increase incentives directed to the network-enabled device in response to determining consistent deviations from the customer. In another example, a service plan allocating a number of movie rentals per period of time can be modified and communicated to the network-enabled computing device, e.g., for acceptance by the user, based on the deviation.

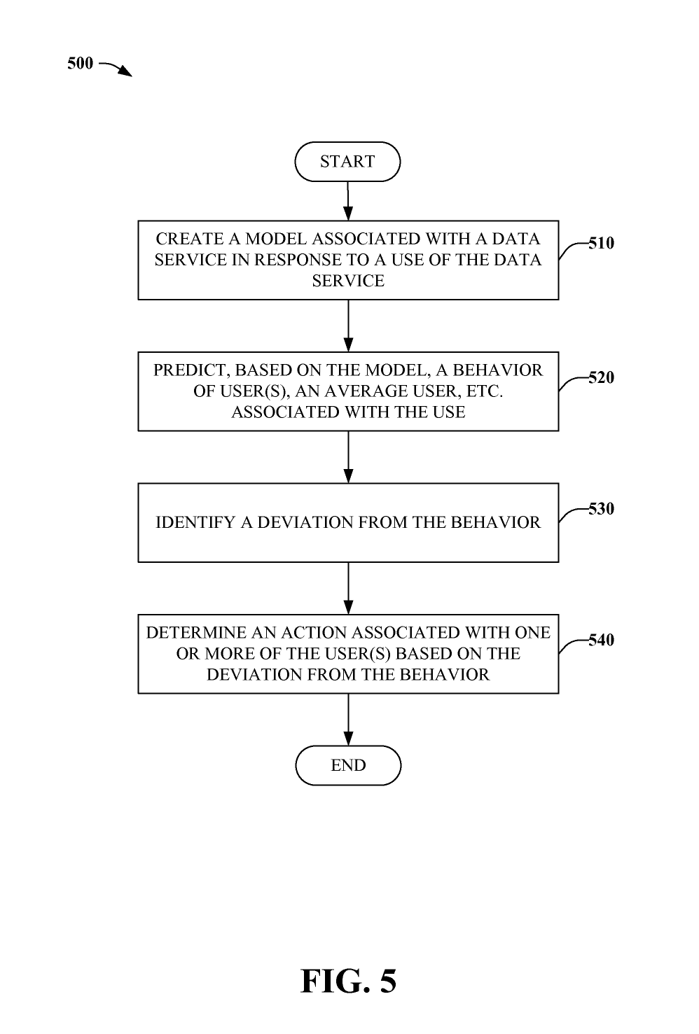

FIGS. 5-8 illustrate methodologies in accordance with the disclosed subject matter. For simplicity of explanation, the methodologies are depicted and described as a series of acts. It is to be understood and appreciated that the subject innovation is not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 5, a process 500 associated with a data service system, e.g., 102, 200, 300, 400, etc. is illustrated, in accordance with one or more embodiments. At 510, a model associated with a data service, e.g., a VOD data streaming service, can be created based on a use of the data service, e.g., by a customer of the data service, by a user of the data service, by respective customers of the data service, by respective users of the data service, etc. In an aspect, the use can be associated with respective video rental requests received from the respective customers, users, etc. by the data service via the Internet.

At 520, a behavior, trend, trend in behavior, etc. of the user, the respective customers, the respective users, “an average user”, etc. can be predicted. In one example, a trend in a genre of movies preferred by the average user can be derived, predicted, etc. based on the use of the data service by the respective users, e.g., based on a consensus of movies determined to be preferred by a majority of the respective users. In another example, a trend in an average amount of movie rentals purchased by the average user on a monthly basis, period of time, etc. can be predicted. For example, the trend can be predicted by averaging an amount of movie rentals purchased by the respective users during a month. In this regard, e.g., an overall sales volume of movie rentals per period of time associated with the respective customers, users, etc. can be predicted based on the predicted purchase trend of the average user.

At 530, a deviation from the behavior, the trend, etc. can be identified. For example, process 500 can identify that a user requested, via the data service, information associated with another genre of movies different from the genre of movies predicted to be preferred by the user, e.g., predicted to be preferred by the average user, etc. In another example, process 500 can identify that the user has not requested a movie rental by the 20^{th} day of a month, different from a trend in an average amount of movie rentals predicted to be purchased by the user on a monthly basis, predicted to be purchased by the average user on the monthly basis, etc. being greater than zero.

At 540, an action associated with the user, the respective users, etc. can be determined based on the deviation determined at 530. For example, process 500 can determine to communicate incentive(s) directed to a network-enabled device associated with the user, directed to network-enabled devices associated with the respective users, etc. to encourage the user, the respective users, etc. to rent movies predicted to be preferred by the user, the respective users, etc. In another example, process 500 can determine to communicate incentives directed to the network-enable device(s) to encourage the user, the respective users, etc. to rent movies associated with the genre of movies different from the genre of movies predicted to be preferred by the user, the respective users, etc.

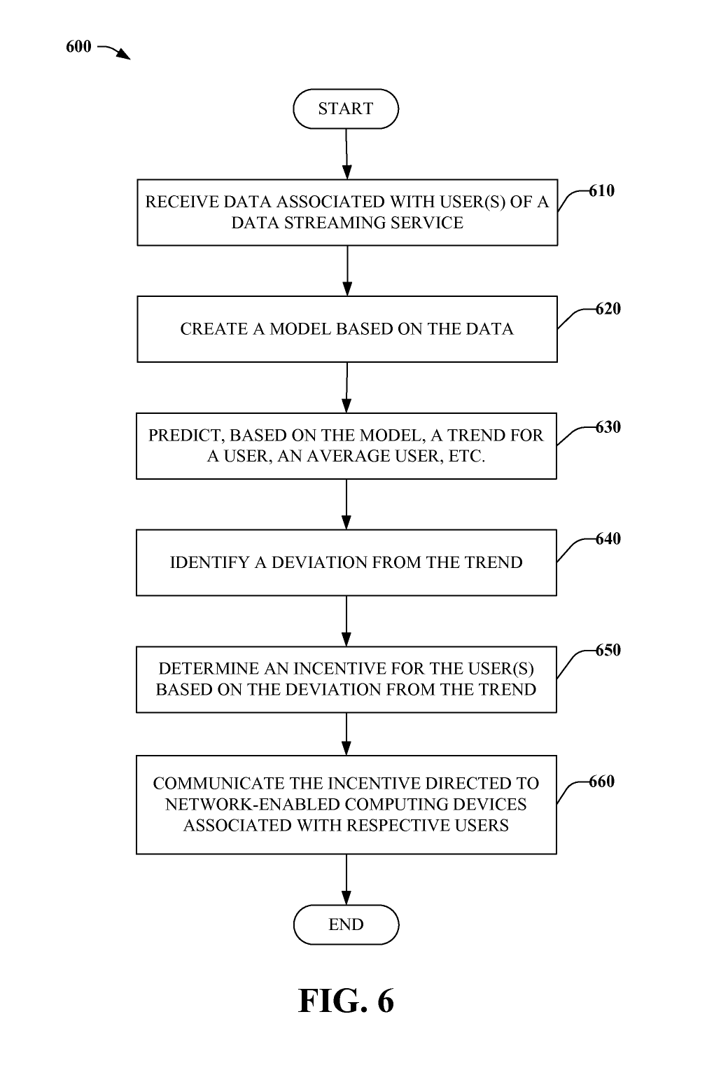

FIG. 6 illustrates another process (600) associated with a data service system, e.g., 102, 200, 300, 400, etc., in accordance with one or more embodiments. At 610, data associated with a user, a customer, respective users, etc. of a service, a data streaming, e.g., VOD, service, etc. can be received. In one or more aspects, the data can indicate: a gender of the user, the respective users, etc., an age of the user, the respective users, etc., a balance of an account of the user, the respective users, etc., e.g., associated with a time of a first purchase by the user, the respective users, etc., an amount of a first deposit into the account, and/or a use of a social network and/or associated profile affiliated with the user, the respective users, etc., e.g., during a registration of the user, the respective users, etc. on the data service. In one or more other aspects, the data can indicate: a number of TVs associated with, or linked to, the user, the respective users, etc., a duration of time of a use of the data service by the user, the respective users, etc., e.g., after the registration, a number of web pages of the data service queried, visited, etc. after the registration, an average time of use of the data service by the user, the respective users, etc. per month, an average duration of movie content rented by, purchased by, etc. the user, the respective users, etc., a total duration of movie content rented by, purchased by, etc. the user, the respective users, etc., and/or a total duration of movie content rented by, purchased by, etc. the user, the respective users, etc. for use, e.g., via a television.

In other aspect(s), the data can indicate: whether a user, respective users, etc. of the data service utilized search features of the data service during a first use, respective uses, etc. of the data service, a number of titles rated by the user, the respective users, etc. during the first use, the respective uses, etc., a number of comments received from the user, the respective users, etc. during the first use, the respective uses, etc., a degree of loyalty of the user, the respective users, etc. to the service, a number of virtual friends of the user, the respective users, etc. that utilize the data service, a total number of devices linked to the service, a total number of holidays in a selected month, and/or a total number of weekend days in a selected month.

Further, at 620, a model can be created based on the data. At 630, a trend, e.g., of behavior, for an “average user/customer”, the user, etc. can be predicted based on the model. For example, the trend can indicate a preferred genre of movie of the user, the average user/customer, etc. In another example, the trend can indicate an average number of movies rented via the data streaming service, e.g., by the average user/customer, by the user, etc. on a monthly basis. In this regard, an estimated target of an amount of sales of movie rentals associated with one or more customers can be derived based on a predicted behavior of the average user/customer.

In one example, the model can be used to predict, at 630, a response, trend, etc. of an average customer, e.g., associated with customers of the data streaming service, to a release of a new product or product offer/incentive. Further, a deviation in customer behavior from the trend, the trend of the average customer, etc. can be identified at 640. In an aspect, an action can be determined, e.g., for the user, for respective customers of the data service, etc. based on the deviation. In another aspect, the action can be associated with development of a revised product and/or another product offer/an incentive (see, e.g., 650 below), e.g., to be communicated to network-enabled computing devices associated with respective customers. In yet another aspect, the model can be optimized, revised, etc. based on the deviation, for example, to improve prediction(s) of customer behavior, to improve prediction(s) of trends of the average user/customer, etc.

At 650, an incentive associated with the user, the respective customers, etc. can be determined based on the deviation in customer behavior from the trend. For example, the incentive can include coupons, movie rental discounts, etc. that can be directed to the user, the respective customers, etc. to facilitate interest in movie rentals associated with the predicted trend, and/or to facilitate interest in movie rentals associated with the deviation, e.g., a deviation in movie genre. At 660, the incentive can be communicated, e.g., via the data service, to a network-enabled computing device associated with the user, to network-enabled computing devices associated with the respective customers, etc.

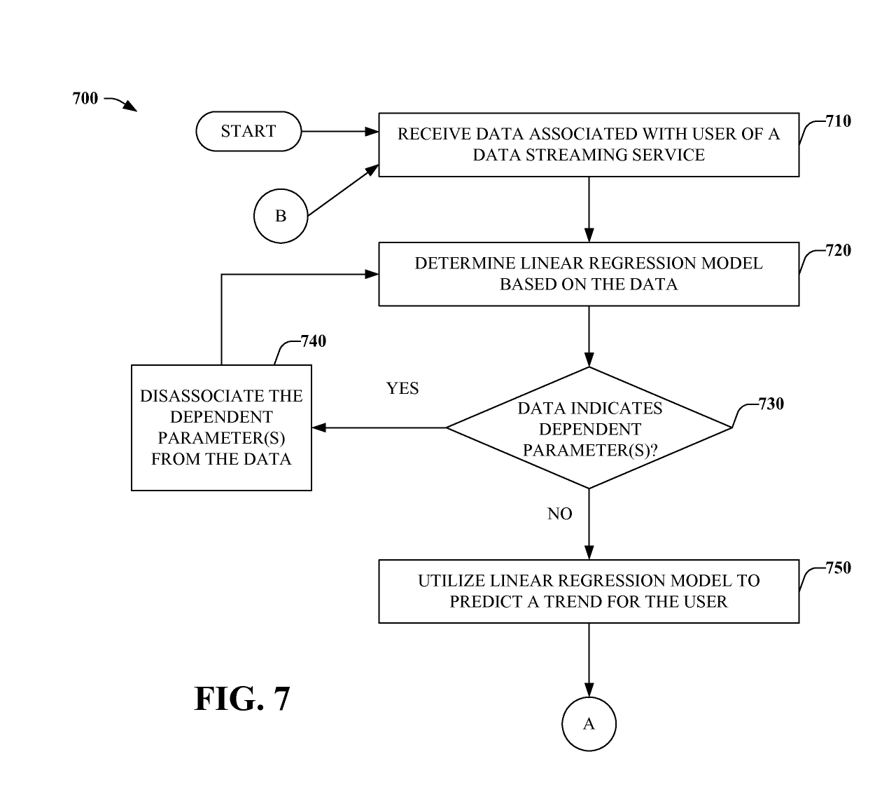

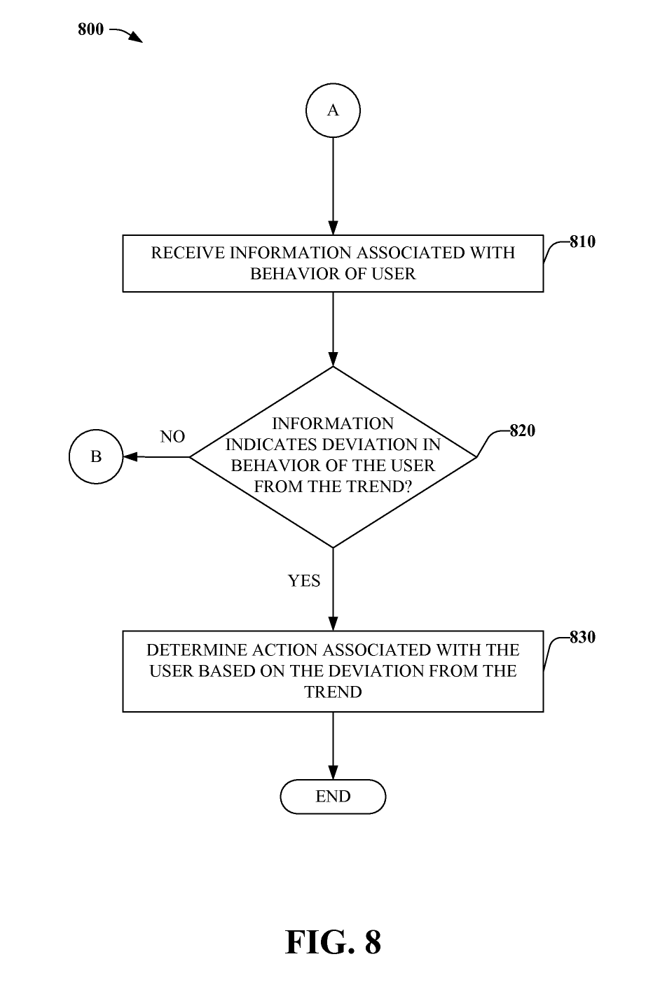

Now referring to FIGS. 7-8, processes (700-800) associated with another data service system, e.g., 102, 200, 300, 400, etc. are illustrated, in accordance with one or more embodiments. At 720, data associated with a user of a data streaming service, e.g., a VOD service, can be received. At 720, a linear regression model can be generated, determined, etc. based on the data. At 730, it can be determined whether the data indicates, includes, etc. dependent parameter(s). If it is determined that the data includes dependent parameter(s), flow continues to 740, at which the dependent parameter(s) can be disassociated, removed, deleted, from the linear regression model; otherwise, flow continues to 750, at which a trend, a behavior, a trend in behavior, etc. of the user can be predicted based on the linear regression model.

Flow continues from 750 to 810, at which information associated with a behavior of the user can be received, detected, etc. In an aspect, such information can be received via polling of an interface of a data service system, e.g., 102, 200, 300, 400, etc. via interface component 210. For example, the information can be received over an Internet Protocol (IP) network, e.g., based on user input data received via a network-enabled device associated with the user. In another aspect, the information can be received over the IP network from an electronic communication account (e.g., a mobile network subscriber account, an e-mail account, a Twitter® account, Facebook® account, . . . ) associated with an account of the user. In yet another aspect, the information can be received from a content profile associated with the account of the user, e.g., stored in data store 112.

At 820, it can be determined whether the information indicates a deviation in behavior of the user from the predicted trend of the user. If it is determined that the information indicates the deviation, flow continues to 830, at which an action for the user can be determined, e.g., the action can include communicating an incentive directed to a network-enabled device associated with the user (see above); otherwise, flow continues to 710.

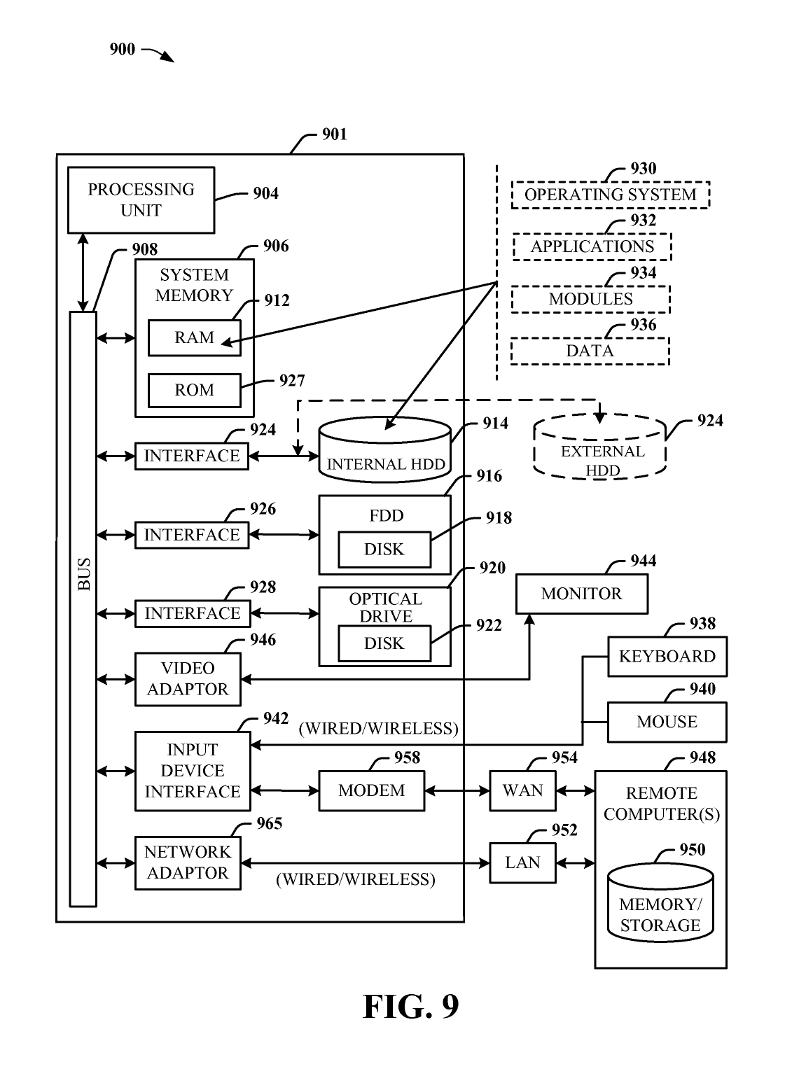

With reference to FIG. 9, a block diagram of a computing system 900 operable to execute the disclosed systems and methods is illustrated, in accordance with an embodiment. Computing system 900 can include a computer 902, the computer 902 including a processing unit 904, a system memory 906 and a system bus 908. The system bus 908 connects system components including, but not limited to, the system memory 906 to the processing unit 904. The processing unit 904 can be any of various commercially available processors. Dual microprocessors and other multi processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 can also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 911 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 994 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules and/or components can be stored in the drives and RAM 912, including an operating system 930, one or more application programs 932, other program modules 934 and program data 936. All or portions of the operating system, applications, modules, and/or data can also be cached in the RAM 912. It is to be appreciated that aspects of the subject disclosure can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 2394 serial port, a game port, a USB port, an IR interface, etc.

A monitor 944 or other type of display device is also connected to the system bus 908 through an interface, such as a video adapter 946. In addition to the monitor 944, a computer typically includes other peripheral output devices (not shown), such as speakers, printers, etc.

The computer 902 can operate in a networked environment using logical connections by wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or can be connected to a communications server on the WAN 954, or has other means for establishing communications over the WAN 954, such as by way of the Internet. The modem 958, which can be internal or external and a wired or wireless device, is connected to the system bus 908 through the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi® and Bluetooth™ wireless technologies. Thus, the communication can be a predefined structure as with a conventional network or simply an ad hoc communication between at least two devices.

Wi-Fi, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), or other bands (e.g., 802.11g, 802.11n, . . . ) so the networks can provide real-world performance similar to the basic 10BaseT wired Ethernet networks used in many offices.

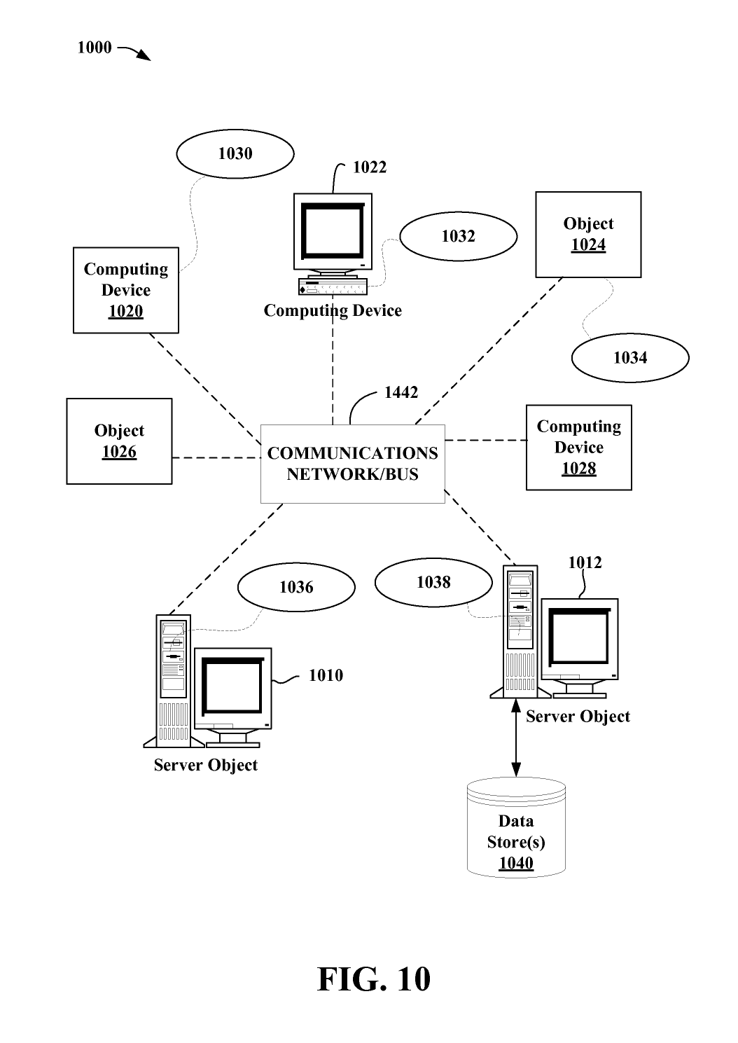

FIG. 10 provides a schematic diagram of an exemplary networked or distributed computing environment. The distributed computing environment comprises computing objects 1010, 1012, etc. and computing objects or devices 1020, 1022, 1024, 1026, 1028, etc., which may include programs, methods, data stores, programmable logic, etc., as represented by applications 1030, 1032, 1034, 1036, 1038 and data store(s) 1040. It can be appreciated that computing objects 1010, 1012, etc. and computing objects or devices 1020, 1022, 1024, 1026, 1028, etc. may comprise different devices, including network-enabled device 120, data store 112, component(s) of data service systems 102, 200, 300, 400, and/or other devices such as a mobile phone, personal digital assistant (PDA), audio/video device, MP3 players, personal computer, laptop, etc. It should be further appreciated that data store(s) 1040 can include data store 112.

Each computing object 1010, 1012, etc. and computing objects or devices 1020, 1022, 1024, 1026, 1028, etc. can communicate with one or more other computing objects 1010, 1012, etc. and computing objects or devices 1020, 1022, 1024, 1026, 1028, etc. by way of the communications network 1042, either directly or indirectly. Even though illustrated as a single element in FIG. 10, communications network 1042 may comprise other computing objects and computing devices that provide services to the system of FIG. 10, and/or may represent multiple interconnected networks, which are not shown. Each computing object 1010, 1012, etc. or computing object or devices 1020, 1022, 1024, 1026, 1028, etc. can also contain an application, such as applications 1030, 1032, 1034, 1036, 1038, that might make use of an API, or other object, software, firmware and/or hardware, suitable for communication with or implementation of the techniques for search augmented menu and configuration functions provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems for search augmented menu and configuration functions as described in various embodiments.

Thus, a host of network topologies and network infrastructures, such as client/server, peer-to-peer, or hybrid architectures, can be utilized. One or more of these network topologies can be employed by network-enabled device 120, data service systems 102, 200, 300, 400, etc. for communicating with a network. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 10, as a non-limiting example, computing objects or devices 1020, 1022, 1024, 1026, 1028, etc. can be thought of as clients and computing objects 1010, 1012, etc. can be thought of as servers where computing objects 1010, 1012, etc., acting as servers provide data services, such as receiving data from client computing objects or devices 1020, 1022, 1024, 1026, 1028, etc., storing of data, processing of data, transmitting data to client computing objects or devices 1020, 1022, 1024, 1026, 1028, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1042 or bus is the Internet, for example, the computing objects 1010, 1012, etc. can be Web servers with which other computing objects or devices 1020, 1022, 1024, 1026, 1028, etc. communicate via any of a number of known protocols, such as the hypertext transfer protocol (HTTP). Computing objects 1010, 1012, etc. acting as servers may also serve as clients, e.g., computing objects or devices 1020, 1022, 1024, 1026, 1028, etc., as may be characteristic of a distributed computing environment.

It is to be noted that aspects, features, or advantages of the disclosed subject matter described in the subject specification can be exploited in substantially any wireless communication technology. For instance, Wi-Fi, WiMAX, Enhanced GPRS, 3GPP LTE, 3GPP2 UMB, 3GPP UMTS, HSPA, HSDPA, HSUPA, GERAN, UTRAN, LTE Advanced. Additionally, substantially all aspects of the disclosed subject matter as disclosed in the subject specification can be exploited in legacy telecommunication technologies; e.g., GSM. In addition, mobile as well non-mobile networks (e.g., internet, data service network such as internet protocol television (IPTV)) can exploit aspects or features described herein.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one memory storing computer-executable instructions; and
at least one processor, communicatively coupled to the at least one memory, which facilitates execution of the computer-executable instructions to at least:
create a model associated with a service based on information associated with a use of the service;
predict, based on the model, a behavior of a user associated with the use of the service; and
identify a deviation from the behavior and determine an action associated with the user based on the deviation from the behavior.

2. The system of claim 1, wherein the service includes at least one of a data streaming service or a video-on-demand (VOD) service.

3. The system of claim 1, wherein the information indicates at least one of: a gender of a customer of the service, an age of the customer, a balance of an account of the customer associated with a time of a first purchase by the customer, an amount of a first deposit into the account, or a use of a social network profile associated with the customer during a registration associated with the service.

4. The system of claim 1, wherein the information indicates at least one of: a number of televisions associated with a customer of the service being linked to the service, a duration of time of a use of the service by the customer after the registration, a number of web pages associated with the service queried after the registration, an average time of use of the service by the customer per month, or a duration of movie content rented by the customer, a total duration of movie content rented by the customer, or a total duration of movie content rented by the customer for use via a television.

5. The system of claim 1, wherein the information indicates at least one of: whether a customer of the service utilized search features of the service during a first use of the service, a number of titles rated during the first use, a number of comments received from the user during the first use, a degree of loyalty of the customer to the service, a number of virtual friends of the customer utilizing the service, a total number of devices linked to the service, a total number of holidays in a selected month, or a total number of weekend days in a selected month.

6. The system of claim 1, wherein the behavior includes at least one of: a total number of rentals of media content requested from the service by the user during a period of time; or a genre of media content of interest to the user.

7. The system of claim 1, wherein the at least one processor further facilitates execution of the computer-executable instructions to:
monitor, via the service, at least one activity associated with a network-enabled device associated with the user; and
identify the deviation in response to the at least one activity being different than the behavior.

8. The system of claim 7, wherein the at least one activity includes at least one of a request to rent media content from the service, or a request for a genre of media content.

9. The system of claim 1, wherein the action includes a communication of an incentive directed to a network-enabled device associated with the user.

10. The system of claim 1, wherein the at least one processor further facilitates execution of the computer-executable instructions to:
generate a linear regression model associated with the service based on data associated with the user; and
predict the behavior of the user based on the linear regression model.

11. The system of claim 1, wherein the at least one processor further facilitates execution of the computer-executable instructions to:
iteratively disassociate dependent parameters from the linear regression model based on the data associated with the user.

12. The system of claim 1, wherein the at least one processor further facilitates execution of the computer-executable instructions to:
modify a service plan associated with the service based on the deviation from the behavior.

13. A method, comprising:
creating, by a system including at least one processor, a model of behavior associated with a service in response to a use of the service;
predicting, by the system based on the model of the behavior, a behavior of a user associated with the use;
identifying, by the system, a deviation from the behavior; and
determining, by the system based on the deviation, an action associated with the user.

14. The method of claim 13, wherein the determining further comprises:
determining, by the system based on the deviation, an incentive; and
communicating, by the system, the incentive directed to a networked-enabled computing device associated with the user.

15. The method of claim 13, where the creating the model of behavior further comprises:
updating, by the system, a linear regression model associated with the service based on data associated with the user.

16. The method of claim 15, wherein the updating further comprises:
iteratively removing, by the system, dependent parameters from the linear regression model based on the data associated with the user.

17. The method of claim 13, wherein the predicting further comprises at least one of:
predicting, by the system, a total number of rentals of media content associated with the user and requested from the service during a period of time; or
predicting, by the system, a genre of media content of interest to the user.

18. The method of claim 13, wherein the identifying the deviation further includes:
detecting, by the system, at least one activity associated with a network-enabled device associated with the user; and
determining, by the system, the deviation in response to the at least one activity being different from the behavior.

19. The method of claim 18, wherein the detecting the at least one activity further includes receiving, by the system, at least one of:
a request associated with a rental of media content; or
a request for a genre of media content.

20. The method of claim 13, further comprising:
modifying a service plan associated with the service based on the deviation from the behavior.

21. A computer-readable storage medium comprising computer-executable instructions that, in response to execution, cause a system including at least one processor to perform operations, comprising:
receiving data associated with a user of a data streaming service;
creating a model associated with the user based on the data;
predicting, based on the model, a trend of behavior of the user;
identifying a deviation from the trend; and
determining an incentive for the user based on the deviation.

22. The computer-readable storage medium of claim 21, the operations further comprising:
communicating the incentive directed to a network-enabled device associated with the user.

23. The computer-readable storage medium of claim 21, wherein the creating further comprises:
creating a linear regression model based on the data; and
in response to determining the linear regression model includes dependent parameters, disassociating the dependent parameters from the data.
